(19) United States
(12) Patent Application Publication
(10) Pub. No.: US 2026/0210888 A1
(43) Pub. Date: Jul. 23, 2026

(54) ELECTRO-MAGNETIC-THERMAL MONITORING SYSTEMS AND RELATED METHODS

(71) Applicant: Battelle Energy Alliance, LLC, Idaho Falls, ID (US)

(72) Inventors: Tae-Sic Yoo, Idaho Falls, ID (US); David L. Zirker, Idaho Falls, ID (US); David C. Horvath, Idaho Falls, ID (US)

(21) Appl. No.: 19/454,219

(22) Filed: Jan. 20, 2026

Related U.S. Application Data
(60) Provisional application No. 63/747,655, filed on Jan. 21, 2025.

(51) Int. Cl. G01N 25/48; G01N 25/04

(52) U.S. Cl. CPC G01N 25/4866; G01N 25/04

(57) ABSTRACT

A method for determining a material composition of a sample comprises heating a sample having an unknown material composition to an elevated temperature, cooling the sample to a baseline temperature, measuring phase changes of the sample, generating a temperature curve of the sample between the elevated temperature and the baseline temperature, and comparing the temperature curve of the sample to a known temperature curve. Additional methods and electro-magnetic thermal (EMT) monitoring systems are disclosed.

### CROSS-REFERENCE TO RELATED APPLICATIONS

This application claims the benefit under 35 U.S.C. § 119(e) of U.S. Provisional Patent Application Serial No. 63/747,655, filed January 21, 2025, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to a monitoring system and a method of material composition analysis. More specifically, embodiments of the disclosure relate to electro-magnetic-thermal monitoring systems and methods.

### BACKGROUND

Material characterization of unknown compounds is a known problem across numerous fields. Existing solutions, such as differential scanning calorimetry (DSC), X-ray fluorescence (XRF), and laser-induced breakdown spectroscopy (LIBS), while effective, are slow and/or expensive. In the field of nuclear safeguards, quickly and accurately characterizing and identifying materials is extremely valuable, and more effective solutions for this process are desired in the field.

### BRIEF SUMMARY

A method for determining a material composition of a sample is disclosed. The method includes heating a sample having an unknown material composition to an elevated temperature. The method includes cooling the sample to a baseline temperature. The method includes measuring temperatures of the sample and generating a temperature curve of the sample between the elevated temperature and the baseline temperature. The method includes comparing the temperature curve of the sample to a known temperature curve.

An electromagnetic-thermal monitoring system for determining a material composition is disclosed. The electromagnetic-thermal monitoring system includes a sample and an induction heating element in thermal communication with the sample. The induction heating element is adjacent to the sample and configured to produce an electromagnetic field proximal to the sample. The electromagnetic-thermal monitoring system includes a thermal sensor in thermal communication with the sample. The thermal sensor is configured to measure temperature changes at a focal point of the sample. The electromagnetic-thermal monitoring system includes a processor configured to receive temperature data from the thermal sensor.

A method for determining a material composition of a sample is disclosed. The method includes heating a sample having an unknown material composition to an elevated temperature and cooling the sample to a baseline temperature. The method includes measuring temperatures of the sample while heating the sample and cooling the sample. The method includes correcting the temperatures of the sample based on emissivity. The method includes generating a temperature curve of the corrected temperatures of the sample between the elevated temperature and the baseline temperature. The method includes comparing the temperature curve of the sample to one or more temperature curves of a known material. The method includes determining a material composition of the sample based on comparing the temperature curve of the sample and the one or more temperature curves of the known material.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 illustrates an electro-magnetic-thermal monitoring system in accordance with embodiments of the disclosure.

FIG. 2 illustrates another electro-magnetic-thermal monitoring system in accordance with embodiments of the disclosure.

FIG. 3 illustrates an aerial view of a third electro-magnetic-thermal monitoring system in accordance with embodiments of the disclosure.

FIG. 4 illustrates a method for identifying a material composition of a sample material in accordance with embodiments of the disclosure.

FIG. 5 illustrates a method for identifying a material composition of a sample material in accordance with embodiments of the disclosure.

### DETAILED DESCRIPTION

The following disclosure presents solutions for rapid characterization of unknown materials or compositions. Electro-magnetic thermal (EMT) monitoring systems disclosed herein may be used to determine a composition (e.g., a material composition, a chemical composition) of the unknown material (e.g., a sample). Rapid characterization of the material may be important to ensure proper safeguards and storage of the material. The EMT monitoring systems and methods according to embodiments of the disclosure may be used to identify, for example, the chemical composition of a material, such as a material used in a nuclear facility. However, the embodiments herein are not so limited and may be used in various fields involving material fabrication and use. Methods of using the EMT monitoring system to determine the chemical composition may use induction heating to rapidly heat a region (e.g., a small area, a localized region) of the material. A temperature sensor is used to measure temperature evolution at the region of the material. The region of the material may be quickly heated, such as by induction heating, and then cooled. The heating and cooling of the localized region may be measured by a temperature sensor to generate temperature curves that are characteristic of phase transitions of the material. The temperature curves may be compared to those in available databases, such as differential scanning calorimetry (DSC) databases and alloy phase diagrams, to determine the chemical composition of the material. In addition to determining the chemical composition of the material, the EMT monitoring systems and methods may be used to identify defects in the material.

The illustrations presented herein are not actual views of any EMT monitoring system, or any component thereof, but are merely idealized representations, which are employed to describe embodiments of the invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, spatially relative terms, such as “beneath,” “below,” “lower,” “bottom,” “above,” “upper,” “top,” “front,” “rear,” “left,” “right,” and the like, may be used for ease of description to describe one element’s or feature’s relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” may encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). For example, “about” in reference to a numerical value may include additional numerical values within a range of from 90.0 percent to 108.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

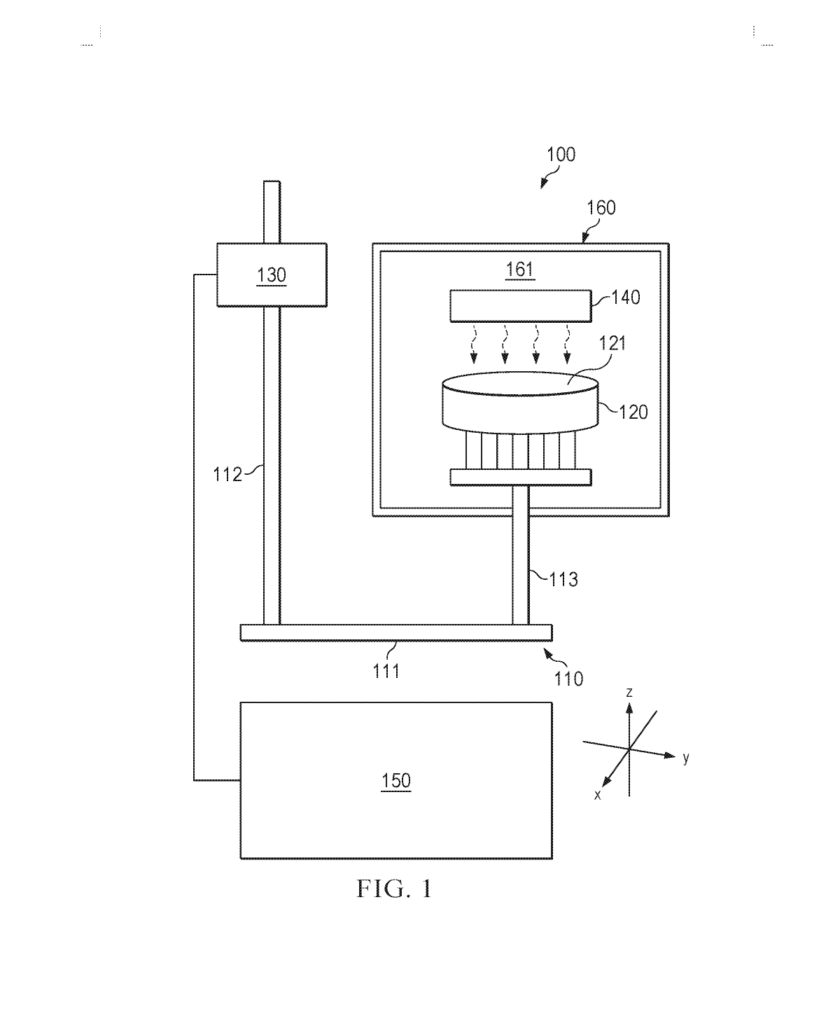

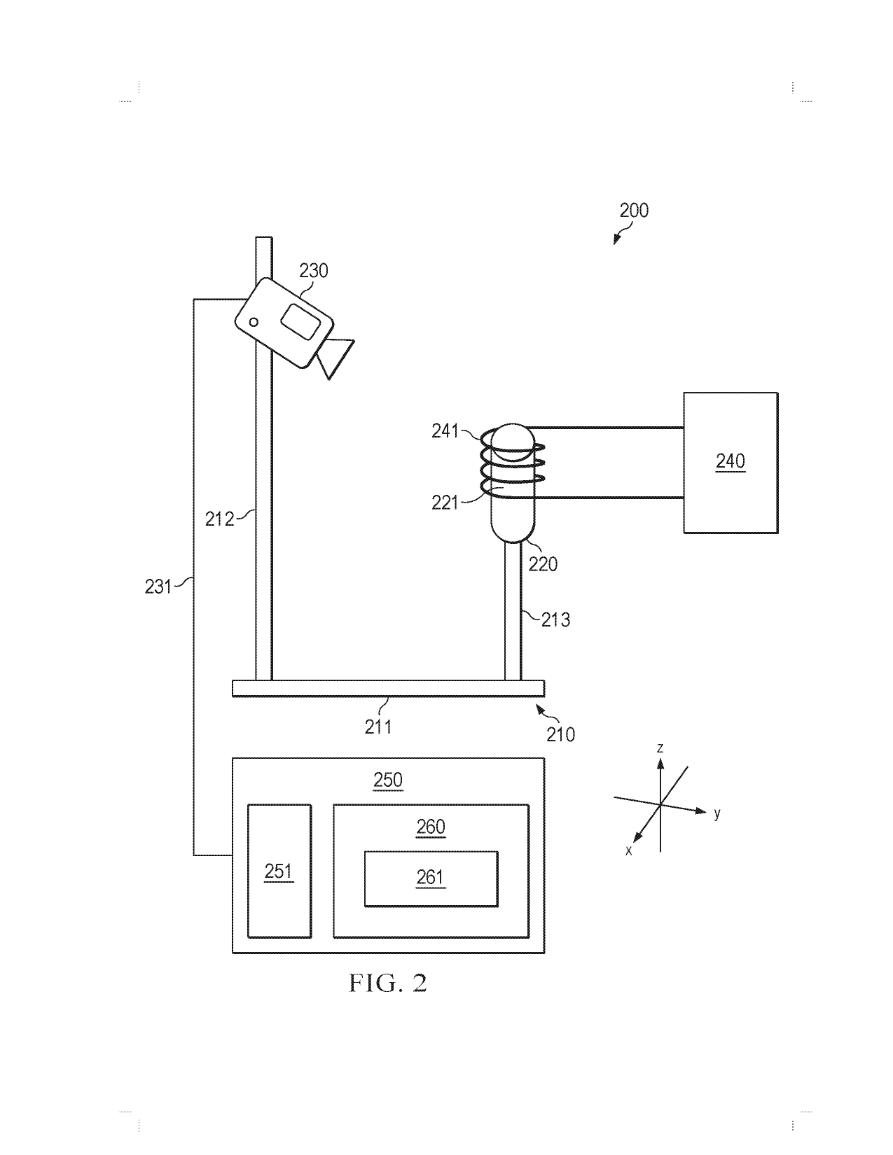

FIGS. 1 and 2 are simplified views illustrating EMT monitoring systems 100, 200. With the description provided below, it will be readily apparent to one of ordinary skill in the art that the methods described herein may be implemented with various embodiments consistent with the teachings herein. The EMT monitoring systems 100, 200 may use induction heating and thermal monitoring to determine the chemical composition of the material to be analyzed. However, other methods of heating may be used.

With reference to FIG. 1, an EMT monitoring system 100 may contain a frame 110, a sample 120 to be analyzed, a thermal sensor 130, a heating element 140, and a processor 150. While FIGS. 1 and 2 illustrate specific embodiments of the EMT monitoring systems 100, 200, other configurations of components of the EMT monitoring systems 100, 200 are possible. The heating element 140 and the sample 120 may be positioned within an enclosure 160 that includes an inert (e.g., substantially free of oxygen) environment 161 to prevent the oxidation of the sample 120 while being heated by the heating element 140 as long as the enclosure 160 provides a clear line of sight between the thermal sensor 130 and the sample 120. In some embodiments, the enclosure 160 is an isolation barrier, such as a glovebox or a specialized hot cell with heavy shielding and remote manipulation capabilities. The enclosure 160 may be a laboratory glove box such as the MBRAUN MB-200B or a glovebox workstation such as the MBRAUN LABstar pro. The inert atmosphere 161 may contain under 50 parts per million (ppm) of oxygen and under 5 ppm of water. The inert atmosphere 161 may include an inert gas such as argon, nitrogen, helium, or the like. If, however, the sample 120 to be tested is not susceptible to oxidation, atmospheric conditions may be used to analyze the sample 120.

An oxidation layer formed on the surface of a sample 120 may substantially change emissivity of the sample 120 during the thermal monitoring of the sample 120, such as during a heating and cooling period. Emissivity is defined as how well the material radiates heat energy at a given temperature compared to an ideal blackbody and ranges from 0 (perfect reflector) to 1 (perfect emitter). The impact of emissivity may be considerable as a thermal sensor may interpret a material with low emissivity (such as 0.1) to be at a fraction of its true temperature. Emissivity is extremely difficult to predict, as it varies with temperature, surface microstructure, surface roughness, angle of observation, and wavelength of observation.

An EMT monitoring system 100 may employ a methodology for correcting the measured temperature of a sample 120 based on the emissivity of the material. One approach to account for emissivity is to actively correct the temperature registered by the thermal sensor 130 by including a material of known emissivity in the same thermal environment within the thermal sensor’s 130 field of view to function as a temperature reference. Another strategy is to include a second measurement device, such as a thermocouple, to measure the baseline temperature of the sample 120. The raw signal of the thermal sensor 130 may be calibrated against this information to determine the true temperature profile. Yet another metal-specific approach is to intentionally oxidize the surface of the sample 120 until the metal oxide layer is thick and uniform. Further oxidation should not occur appreciably during subsequent experimentation, giving a stable and relatively narrow emissivity approximation.

A component (e.g., thermal sensor 130) of the EMT monitoring system 100 may be coupled so that a temperature of the sample 120 may be measured and analyzed. The frame 110 of the EMT monitoring system 100 may have a base 111. The frame 110 may have a thermal sensor translator 112, which allows the thermal sensor 130 to move relative to the sample 120. The thermal sensor translator 112 may be a rail, series of attachment points, or similar structure for securing one or more thermal sensors 130 to the frame 110. The frame 110 may also have a sample contact point 113, where the sample contact point 113 is coupled to the frame 110. The sample contact point 113 may include a series of small surfaces, such as pins, to support the sample 120. The sample contact point 113 may be a clamping mechanism. The sample contact point 113 may couple to the sample 120 at one or more locations along the sample 120. The sample contact point 113 may be made of a heat-insulative material, such as plastic, rubber, glass fiber, ceramic material, or other materials with low thermal conductivity known in the art to prevent heat transfer from the sample 120 to the frame 110 during heating. The frame 110 may be made of various materials, including aluminum, titanium, steel, metal alloys, and plastic.

The sample 120 may be coupled to the frame 110 at the sample contact point 113. The sample 120 may vary in size and shape. For example, the sample 120 may have a length in a range from about 2 cm to about 200 cm. The sample 120 may have similar dimension ranges for width and height. The sample 120 may be configured as a rod, a rodlet, or another shape proximal to which the heating element 140 is located. The sample 120 may include a focal point 121 where the heating element 140 thermally communicates with the sample 120. The focal point 121 may be a substantially flat (e.g., planar) region where heating of the sample 120 is localized during use and operation of the EMT monitoring system 100. The focal point 121 may be a portion of an area around the sample 120, such as around the circumference of the sample 120 if the sample 120 is shaped as a rod. The focal point 121 may be a curved area around an area of the sample 120. The focal point 121 may be located at the thinnest cross-sectional area of the sample 120. The sample 120 may have more than one focal point 121.

The sample 120 may be an electrically conductive material, such as a metal material, a non-electrically conductive material, or a semiconductive material. If a non-electrically conductive material is to be analyzed, the heating element 140 includes a metal susceptor (not shown) in addition to an induction heater and an induction coil. The metal susceptor may be present between the induction coil of the heating element 140 and the sample 120 and used to indirectly heat the sample 120. By way of example only, the sample 120 may be one or more of a metal, a metal alloy, a salt (e.g., a halide salt, a molten salt), an oxide, and an organic compound. The sample 120 may include, but is not limited to, a ceramic, glass, a plastic, an organic compound, or a non-organic compound. By way of example only, the sample 120 may include uranium, plutonium, zirconium, neodymium, cerium, molybdenum, or aluminum. The sample 120 may be a metal alloy, including iron (e.g., steel), copper (e.g., brass), or uranium, plutonium, and transplutonium metals. Phase change (e.g., phase transition) temperatures of the material of the sample 120 may be known from databases and a phase change temperature signature of the sample 120 may be determined by comparing the phase change temperatures to that of known materials. The phase change may be a change from a solid phase of the material to a liquid phase of the material, a solid phase to a gas phase, or a liquid phase to a gas phase. Likewise, a change in crystalline structures of the material of the sample 120 may be determined by comparing the crystalline change temperatures to that of known materials. For example, ferromagnetic materials undergo a Curie transition at a specified temperature. The sample 120 may be a nuclear material that is being monitored to prevent proliferation and safeguard the material.

The sample 120 may be partially or entirely surrounded by the heating element 140 proximal to the focal point 121. The focal point 121 may be adjacent to the heating element 140. The focal point 121 may be the region of the sample 120 from which the thermal sensor 130 gathers temperature data. While a single focal point 121 is indicated in FIG. 1, the sample 120 may be analyzed at one or more focal points 121 along the sample 120 in a series of consecutive tests.

The thermal sensor 130 may be configured to measure a temperature at the focal point 121 of the sample 120 over time. The phase change may be detectable to the thermal sensor 130 to a precision of about 4°C. The thermal sensor 130 may be a thermal imaging camera, such as an infrared camera, but it may also be an infrared temperature sensor or similar temperature-measuring device. The thermal sensor 130 may be an Optris PI 1N IR camera that includes a high dynamic CMOS detector with up to 764 x 480 pixel resolution having a 27 Hz framerate. The CMOS detector may have a spectral range of from about 0.85 µm to about 1.1 µm and may be capable of measurement between about 450°C and about 1800°C in the 27 Hz mode. Data from the thermal sensor 130 may be processed via software such as PIX Connect software by Optris. While FIG. 1 shows the thermal sensor 130 located a distance away from the sample 120, the thermal sensor 130 may be in direct contact with the sample 120. One or more thermal sensors 130 may be displaced at various distances of the sample 120 depending on the size of the sample 120, the type of thermal sensor 130, and the maximum temperature of the sample 120 desired. The one or more thermal sensors 130 may be displaced at various distances, in all of the x, y, and z axes, away from the sample 120, and may move independently of the other thermal sensors 130. The thermal sensor 130 may be coupled to the thermal sensor translator 112 or may be coupled to the sample contact point 113.

The thermal sensor 130 may be angled to monitor the temperature of the sample 120 in different positions. The thermal sensor 130 may include one or more thermal sensors 130 positioned at different locations relative to the sample 120. The thermal sensors 130 may include the same type of sensor, such as multiple infrared cameras, or may include multiple different kinds of sensors. The thermal sensor 130 may be radiation hardened (10-to-10,000-fold radiation reduction) to reduce noise, disruption, or damage to the thermal sensor 130. Direct exposure of potential radiation to the thermal sensor 130 may be minimized through distancing techniques. For example, the thermal sensor 130 may be configured to view the sample 120 indirectly through the use of mirrors.

The heating element 140 may produce heat in the form of conduction, convection, or induction. The heating element 140 may be configured to heat the sample 120 to a temperature in excess of about 800°C. In some embodiments, the heating element 140 may be configured to heat the sample 120 to a temperature in excess of about 1200°C. The heating element 140 may heat the sample 120 at a rate of greater than about 9000°C/min. The heating element 140 may be a warming lamp, an induction heater, a gas heater, or other heating device known in the art. The heating element 140 may be an induction heater that may be configured to quickly heat the sample 120 at the focal point 121. Therefore, the heating element 140 may be described herein as an induction heater but is not so limited. One or more heating elements 140 working in tandem to elevate the temperature of the focal point 121 of the sample 120 may be used. The heating elements 140 may also heat multiple focal points 121 of the sample separately. The heating elements 140 may include the same type of heating element 140 or may include different types of heating elements 140.

The heating element 140 may be configured to produce an amperage in a range from about 100 amps to about 600 amps, which locally heats the sample 120. The sample 120 may be heated and allowed to cool without forming a molten state of the material of the sample 120. The sample 120 may be allowed to cool for a specified amount of time. For example, the sample 120 may cool for sixty (60) seconds or less. In embodiments, the sample 120 may be allowed to cool for thirty (30) seconds or less.

The thermal sensor 130 may be in communication with (e.g., electrical communication with) a processor 150 and the sample 120. The processor 150 may be a computer, a tablet, or other microelectronic device with a memory. The processor 150 may record the temperature of the focal point 121 of the sample 120 over time by using the data collected by the thermal sensor 130. The processor 150 may display the data in the form of a graphical display, chart, or other suitable display. The temperature of the sample 120 may be collected using, for example, a thermal camera. If a metal susceptor is used to analyze the sample 120, the thermal sensor 130 may be configured to read the temperature of the sample 120, allowing for simultaneous visual observations and temperature evolution measurements of the sample 120.

FIG. 2 illustrates an EMT monitoring system 200 with a frame 210, a sample 220, an infrared camera 230, an induction heater 240, and a computer 250.

The frame 210 may be supported by a base 211 and coupled to a sample 220 at a sample contact point 213. The sample contact point 213 may, for example, clamp to an end of the sample 220. The frame may also be coupled to an infrared camera 230 along a rail 212.

As described above with reference to FIG. 1, the sample 220 may be an alloy of plutonium, uranium, and various transplutonium metals or one or more other metals. The sample 220 may be a nuclear fuel rod or other commonly used fuel types for nuclear fission. The sample 220 may have an atomic concentration percentage of uranium in a range from about 0.0 percent to about 100.0 percent, such as from about 0.1 percent to about 99.0 percent, from about 90.0 percent to about 97.0 percent, or from about 94.0 percent to about 96.0 percent. The sample 220 may have an atomic concentration percentage of plutonium in a range from about 0.0 percent to about 100.0 percent, such as from about 0.1 percent to about 5.0 percent, from about 0.3 percent to about 1.0 percent, or from about 0.4 percent to about 0.6 percent.

The infrared camera 230 may be positioned along the rail 212 at a height sufficient to observe the sample 220 without line-of-sight interference from the induction heater 240. The induction heater 240 may be repositioned out of the line of sight to improve temperature readings over a wider spatial range. The infrared camera 230 may be positioned above, at the same level as, or below the level of the sample 220. The infrared camera 230 may be focused on a focal point 221 of the sample 220. The infrared camera 230 may be coupled to a computer 250 and transmit data 231 to the computer 250. The infrared camera 230 may be connected to the computer 250 physically, or may send remote signals to the computer 250 using known methods in the art. While FIG. 2 describes and illustrates the infrared camera 230, other types of thermal sensors may be used in place of the infrared camera 230.

The induction heater 240 may be connected to an induction coil 241. The induction heater 240 may be capable of producing amperages in a range from about 100 amps to about 600 amps, from about 200 amps to about 500 amps, or from about 300 amps to 400 amps. The induction coil 241 may be formed from and include a rigid material or a flexible material. The induction coil 241 may maintain a shape around the sample 220, such as being coiled around the sample 220 one or more times. The induction coil 241 may be closest to the sample 220 at the focal point 221. In some embodiments, the induction coil 241 is 7.94 mm copper tubing having a 2.52 cm inner diameter. The induction coil 241 may be concentrically looped three (3) times in each of two vertical layers. A chiller (not shown) may circulate a 50/50 glycol mixture through the induction coil at a rate of 33 liters per minute.

The computer 250 may be configured to receive the data 231 from the infrared camera 230. The computer 250 may run a program 251, which may display the data 231 in the form of a graphical display of temperature versus time. The computer 250 may also have a database 260. The database 260 may hold a record of sample data 261 of temperature curves for various model samples. The program 251 may be configured to retrieve information from the database 260 and compare the data 231 to the sample data 261 of the database 260 to determine the identity of the sample 220. The program 251 may identify the sample 220 based on a correlation coefficient between the data 231 and the sample data 261 or other method known in the art.

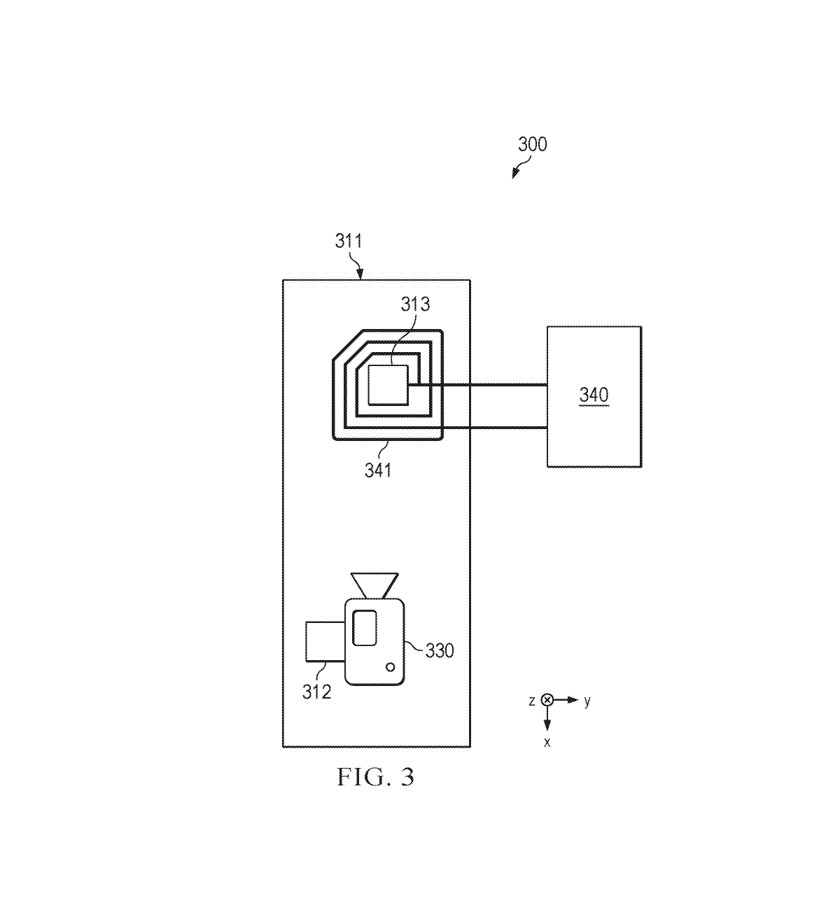

FIG. 3 illustrates an aerial view of an EMT monitoring system 300 including a base 311, a rail 312, a sample contact point 313, an infrared camera 330, an induction heater 340, and an induction coil 341.

The base 311, rail 312, and sample contact point 313 of FIG. 3 may be arranged in a similar manner as FIGS. 1 and 2 but is not so limited. The EMT monitoring system 300 may include an induction heater 340 connected to an induction coil 341. The induction coil 341 may coil, for example, in a spiral pattern in an x-y plane around the sample contact point 313. The induction coil 341 may spiral around (e.g., surround) the entirety or a portion of the sample contact point 313. An arrangement of the induction coil 341 in a spiral pattern may allow a sample (not shown), such as the sample 220 of FIG. 2, proximal to the sample contact point 313 to be heated across a flat plane parallel to the induction coil 341. A sample may be clamped, held on pins, or otherwise fixed on the sample contact point 313 in such a manner that allows for uniform heating of a focal point, such as a planar surface, of the substrate by the induction coil 341.

While the induction coil 341 is illustrated as spiraling in a planar manner, it is not so limited. The flexibility of the material of the induction coil 341 may allow the induction coil 341 to be arranged in a variety of three-dimensional patterns to fit (e.g., match) the contour of samples to be heated and analyzed using the methods described herein. In this way, the induction coil 341 may fit the contour of various sample shapes, and more easily heat focal points of those samples using the methods described herein.

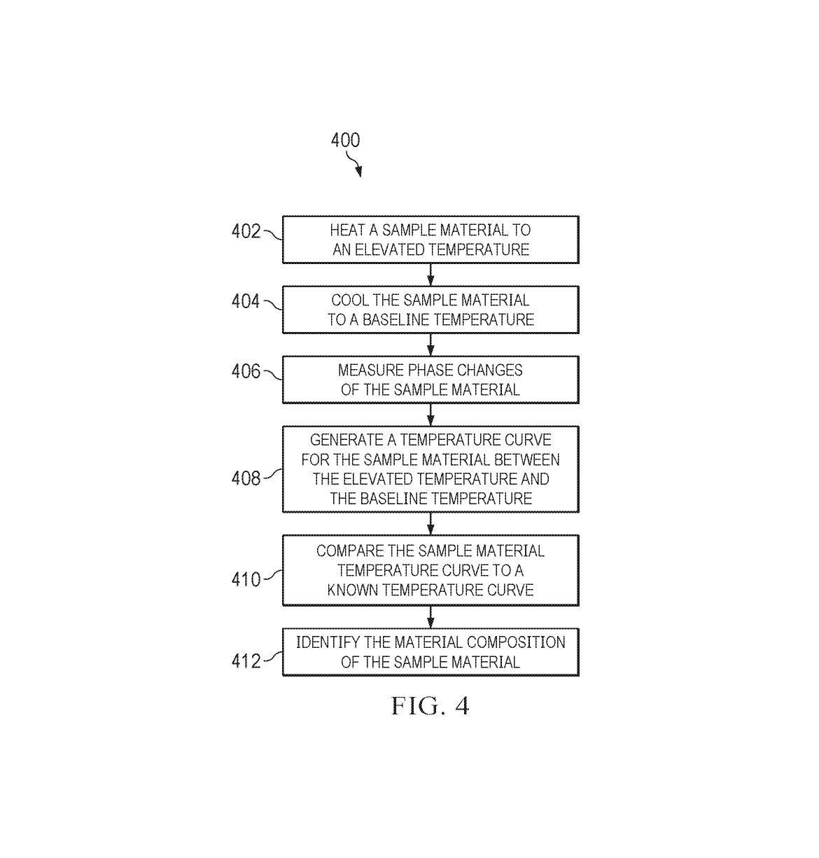

FIG. 4 illustrates a process 400 for identifying an unknown sample material, such as the sample 220 of FIG. 2, including heating a sample material to an elevated temperature 402, cooling the sample material to a baseline temperature 404, measuring phase changes 406 of the sample material, generating a temperature curve 408 for the sample material between the elevated temperature and the baseline temperature, comparing 410 the sample material temperature curve to a known temperature curve, and identifying 412 the material composition of the sample material. For convenience, the process of FIG. 4 is described with reference to the EMT monitoring system 200 of FIG. 2 but is not limited to the embodiment of FIG. 2. For example, the process 400 may be used for identifying an unknown sample material such as the sample 120 of FIG. 1 or the sample contact point 313 of FIG. 3. The baseline temperature 404 may vary depending on the application. In some embodiments, the baseline temperature 404 is room temperature. In yet other embodiments, the baseline temperature 404 is 450°C.

During the process 400, the induction heater 240 may transfer an amperage to the induction coil 241. The amperage may range from about 100 amps to about 600 amps, from about 200 amps to about 500 amps, or from about 300 amps to about 400 amps. The amperage flowing through the induction coil 241 may produce an electromagnetic field in the vicinity of the induction coil 241. The induction coil 241, being near the sample 220, produces an electromagnetic effect on the sample 220 that causes the sample 220 to quickly rise in temperature (e.g., quickly heat) at a focal point 221. Accordingly, the sample 220 is heated to an elevated temperature. The elevated temperature may be a desired maximum temperature, or may be the maximum temperature achievable for the set amperage of the induction heater. The temperature at the focal point 221 may be measured over time by the infrared camera 230. The change in temperature may be sufficient to cause a change in phase or a change in crystal structure of the sample.

As the sample 220 rises in temperature, the infrared camera 230 measures the temperature at the focal point 221 of the sample 220 over a time interval. The time interval may be from about 2 minutes to about 30 minutes, from about 3 minutes to about 10 minutes, or from about 4 minutes to about 5 minutes. The time interval may depend on the amperage of the induction coil 241 and the material of the sample 220. The infrared camera 230 measures the rise in temperature of the sample 220. Once the sample 220 reaches the desired elevated temperature, the induction heater 240 may be turned off. The desired elevated temperature may be lower than a melting point of the sample 220, which reduces energy requirements of the EMT monitoring system 200. For example, the sample 220 may undergo a change in crystalline structure, which may be detected, rather than a phase transition. Since reaching the melting point of the material of the sample 220 is not necessary, the process 400 may have lower energy requirements than conventional processes. As the sample 220 cools, the infrared camera 230 measures the temperature of the focal point 221 from the elevated temperature to a baseline temperature. The sample 220 may quickly cool at the focal point 221, such as at a time interval of less than about 2 minutes or less than about 1 minute. Since the heating and cooling of the sample 220 occur quickly, the temperature data may be measured and acquired quickly.

The infrared camera 230 may be in communication with the computer 250. The infrared camera may transmit temperature data 231 to the computer 250. The computer 250 may be configured to run a program 251 that monitors the data 231 from the infrared camera 230 over time. The computer 250, through program 251, may be capable of generating a temperature curve from the data 231 obtained between the elevated temperature and the baseline temperature. The program 251 may present a graph of the sample’s 220 temperature as a function of time. Phase transitions and crystalline structure changes of the sample 220 may be determined based on temperature curves of the sample 220 as it is being heated by the induction heater 240 and as the sample 220 cools. For example, changes in a slope of the temperature curve indicates either a phase transition or change in crystalline structure of the sample 220. The temperature curve may show a sudden increase or a sudden decrease (e.g., a spike in the temperature curve) at a temperature of the phase transition or change in crystalline structure. The program 251 may provide a chart of numerical values of the sample as a function of time to a user. The program 251 may allow the user to identify distinctive phase changes or crystal structure changes of the sample 220 based upon the change in temperature over the time period. Periods where the temperature stays constant may indicate that a phase change has occurred at that temperature. These phase changes may then be compared to a database 260 that has sample data 261 of temperature change curves of various known samples. For instance, phase diagrams in the database 260 may be compared to phase change temperatures of the sample 220. The material composition identification may be based upon phase change temperature signature vector information. Using the sample data 261, the sample 220 may be identified by the user. More specifically, the temperature curves of known sample material compositions may be compared to the sample temperature curve to determine the material composition of the sample 220. For example, a sample 220 of uranium and plutonium with an unknown composition may be compared to temperature curves of plutonium and uranium alloys with various known compositions to determine a most likely identity of the material composition of the sample 220. The data acquisition and analysis may be conducted rapidly, enabling real-time, in-situ monitoring of the sample 220. The quick data acquisition may also enable databases for heating and cooling profiles to be built for training samples and used for materials characterization in field applications. Machine learning may also be implemented to identify the material composition of the sample 220 based on the temperature curves of known sample material compositions compared to the temperature curve of the sample 220.

Additionally, the program 251 may be configured to select the sample data 261 of known sample material compositions from the database 260 and present sample curves to the user. The program 251 may provide correlation data between the data 231 from the infrared camera 230 and the sample data 261 of temperature curves for various model samples within the database 260. The program 251 may provide one or more possible identifications for the sample 220. The program 251 may provide for the material composition of the sample 220.

The EMT monitoring system 100, 200 may be compact and easily transportable, allowing the EMT monitoring system 100, 200 to be used in hazardous environments, such as in nuclear facilities. For instance, the EMT monitoring system 100, 200 may be used to determine the material composition of a nuclear material, such as of a uranium alloy, or to determine defects in nuclear reactor components, such as in nuclear fuel pin examination. The compact size and simple configuration of the EMT monitoring system 100, 200 may enable easy transport of the EMT monitoring system 100, 200 and in situ monitoring in the hazardous environment. By using induction heating, the EMT monitoring system 100, 200 may also reduce the amount of time for acquiring and analyzing the temperature data. The EMT monitoring systems and methods may, therefore, be used to quickly and cheaply determine the chemical composition at a lower cost than conventional systems and methods. The EMT monitoring system 100, 200 may also enable the sample to be analyzed by a non-destructive method, without removing material from containment, which reduces hazards associated with handling and transport of the material. The EMT monitoring systems and methods may, therefore, be less time consuming and resource intensive.

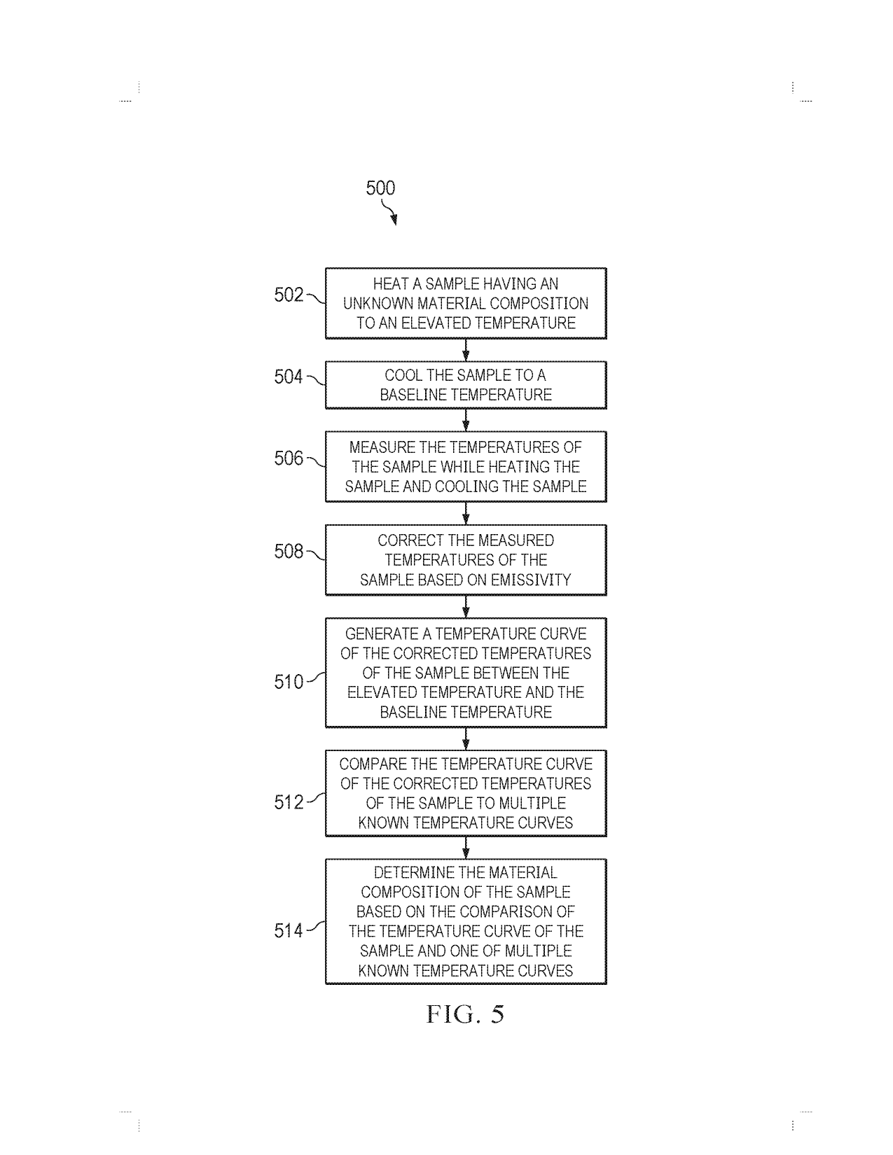

The process 400 for identifying a material composition of an unknown sample material, such as the sample 220 of FIG. 2, may optionally include an emissivity correction as described below for FIG. 5. For example, the black-tape method may be used to provide an emissivity correction. The black-tape method includes a material of known emissivity is heated alongside the sample 220 to generate a continuous calibration for the temperature signal. This correction relies on an assumed steady state between the sample and calibration material, which may be maintained inductively during heating by gradually increasing the magnetic field strength.

A band of high-temperature, known-emissivity paint may be applied directly to the sample, and the temperature at the metal-paint interface may be assumed to be approximately equal across both materials. The observed temperature difference at this interface may then be attributed to emissivity effects and used to derive a correction. For example, the high temperature, known-emissivity paint may be Aremco’s 840-CM, which is advertised to work up to a temperature of about 1093°C. The manufacturer publishes emissivity values up to 900°C, usually on the order of an emissivity value of 0.9.

FIG. 5 is a flow chart illustrating a process 500 for identifying an unknown sample material, such as the sample 220 of FIG. 2. For convenience, the process of FIG. 5 is described with reference to the EMT monitoring system 200 of FIG. 2 but is not limited to the embodiment of FIG. 2. For example, the process 500 may be used for identifying an unknown sample material such as the sample 120 of FIG. 1 or the sample contact point 313 of FIG. 3. At act 502, a sample having an unknown material composition is heated to an elevated temperature. For example, the sample may be heated to an elevated temperature between about 450°C and about 1500°C. The sample may be heated to the elevated temperature by an induction heating element. Various other mechanisms may be used to heat the sample to the elevated temperature as would be appreciated by one of ordinary skill in the art.

At act 504, the sample is cooled to a baseline temperature. In embodiments, the baseline temperature may be room temperature. In yet other embodiments, the baseline temperature may be a temperature between about 450°C and room temperature (e.g., from about 20°C to about 25°C). At act 506, temperatures of the sample are measured while heating the sample and cooling the sample. For example, a thermal sensor in thermal communication with the sample may measure the temperatures of the sample during the heating and cooling processes.

At act 508, the measured temperatures of the sample may be corrected based on emissivity. For example, the emissivity of the sample may cause the measured temperatures of the sample to differ from the actual temperatures of the sample. Various methods may be used to correct the measured temperatures due to emissivity as discussed herein. At act 510, temperature curves of the corrected temperatures of the sample between the elevated temperature and the baseline temperature are generated. For example, a graphical display of the corrected temperatures of the sample may be displayed as a temperature curve.

At act 512, the temperature curve of the corrected temperatures of the sample is compared to multiple known temperature curves. For example, the temperature curve of the corrected temperatures of the sample may be compared to various known temperature curves contained within a database. At act 514, the material composition of the sample may be determined based on the comparison of the temperature curve of the sample and one of the multiple known temperature curves. For example, if the temperature curve of the sample corresponds to a known temperature curve, the material composition of the sample is identified as the material corresponding to the known temperature curve.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A method for determining a material composition of a sample comprising:
heating a sample having an unknown material composition to an elevated temperature;
cooling the sample to a baseline temperature;
measuring temperatures of the sample;
generating a temperature curve of the sample between the elevated temperature and the baseline temperature; and
comparing the temperature curve of the sample to a temperature curve of a material having a known composition.

2. The method of claim 1, further comprising:
identifying the material composition of the sample based on a phase change on the temperature curve of the sample to a phase change on the temperature curve of a material having a known composition.

3. The method of claim 1, wherein cooling the sample to the baseline temperature comprises cooling the sample for sixty (60) seconds or less.

4. The method of claim 1, wherein heating a sample having the unknown material composition to the elevated temperature comprises heating the sample to a temperature lower than a melting point of the sample.

5. The method of claim 1, wherein heating a sample comprises heating the sample using an induction coil.

6. The method of claim 1, wherein generating a temperature curve of the sample comprises generating a graph of the sample’s temperature as a function of time.

7. The method of claim 1, wherein generating a temperature curve of the sample comprises generating a chart of numerical values of the sample’s temperature as a function of time.

8. The method of claim 1, wherein heating a sample having an unknown material composition comprises heating a metal material.

9. The method of claim 1, further comprising:
correcting the measured temperatures of the sample based on emissivity prior to generating the temperature curve of the sample.

10. The method of claim 9, wherein correcting the measured temperatures of the sample based on emissivity comprises heating and cooling a control material having a known emissivity with the sample.

11. The method of claim 1, wherein heating the sample having the unknown material composition to the elevated temperature and cooling the sample to the baseline temperature is performed in an inert environment.

12. The method of claim 11, wherein the inert environment comprises one of argon, nitrogen, or helium.

13. An electromagnetic-thermal monitoring system for determining a material composition, the electromagnetic-thermal monitoring system comprising:
an enclosure configured to hold a sample;
an induction heating element configured to be in thermal communication with the sample within the enclosure, the induction heating configured to produce an electromagnetic field within the enclosure and proximal to the sample;
a thermal sensor configured to be in thermal communication with the sample within the enclosure, the thermal sensor configured to measure temperature changes at a focal point of the sample within the enclosure; and
a processor configured to receive temperature data from the thermal sensor and to determine a distinctive phase change temperature correlating to at least one composition of a sample within the enclosure.

14. The electromagnetic-thermal monitoring system of claim 13, wherein the at least one composition of the sample comprises an alloy.

15. The electromagnetic-thermal monitoring system of claim 13, wherein the processor is further configured to generate a graph of the sample’s temperature changes as a function of time.

16. The electromagnetic-thermal monitoring system of claim 13, wherein the induction heating element comprises an induction heater or an induction coil.

17. The electromagnetic-thermal monitoring system of claim 13, wherein the thermal sensor comprises a thermal imaging camera.

18. The electromagnetic-thermal monitoring system of claim 17, further comprising:
an inert environment within the enclosure, the inert environment including one or more of argon, nitrogen, or helium.

19. A method for determining a material composition of a sample comprising:
heating a sample having an unknown material composition to a temperature below a melting point of the sample;
cooling the sample to a baseline temperature;
measuring temperatures of the sample while heating the sample and cooling the sample;
correcting the measured temperatures of the sample based on emissivity;
generating a temperature curve of the corrected temperatures of the sample between the elevated temperature and the baseline temperature;
comparing the temperature curve of the sample to one or more temperature curves of a known material; and
determining a material composition of the sample based on comparing the temperature curve of the sample and the one or more temperature curves of the known material.

20. The method of claim 19, wherein heating the sample comprises using induction heating to heat the sample.
